(19) United States
(12) Patent Application Publication
(10) Pub. No.: US 2009/0268904 A1
(43) Pub. Date: Oct. 29, 2009

(54) DISPLAY DEVICE FOR VISUALLY RECONSTRUCTING AN IMAGE

(75) Inventors: Antonius Gerardus Hendrikus Verhulst, Veldoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,021

(22) PCT Filed: Dec. 14, 2005
(86) PCT No.: PCT/IB2005/054239

§ 371 Date: Jun. 18, 2007

(30) Foreign Application Priority Data
Dec. 21, 2004 (EP) 04106797.6

(51) Int. Cl. G09C 5/00; G02F 1/1347

(52) U.S. Cl. 380/54; 349/77

(57) ABSTRACT

The invention relates to a display device for visually reconstructing an image (330) from an encoded image (320), such a device being particularly useful in the field of visual cryptography. The display device has two stacked liquid crystalline layers (410, 420) with individually addressable pixels. One layer (420) renders encoded image data together with a randomization pattern, and the other layer (410) only renders a randomization pattern. If the patterns match, the display device shows a visually reconstructed image (330) to a viewer. Means are provided for LC layers, such as a birefringent layer (414) between the two LC layers. Alternatively, two twisted nematic LC layers can be used having opposite twist directions. Such means were found to improve an image quality of the visually reconstructed image, and can in fact be advantageously applied in any display system including a plurality of LC layers cooperating for forming an image.

The invention relates to a display device for visually reconstructing an image from an encoded image. Such a device is particularly useful in the field of visual cryptography.

Visual cryptography can briefly be described as follows. An image is split into two randomized parts, a first part containing an encoded image, which is preferably the original image plus a randomization pattern, and a second part containing only a randomization pattern. Either part contains no discernible information on the original image. However, when an encoded image and a matching randomization pattern are brought together in a suitable device, the original image can be visually reconstructed.

If non-matching parts are brought together, that is the two parts have non-matching randomization patterns, no information on the original image is revealed and a random image is shown on the device. If two parties want to communicate using visual cryptography, they therefore will have to share a key sequence representing the correct randomization pattern.

An implementation of visual cryptography is for example disclosed in international patent application WO 2003/066797 A1. The system used includes a stack of two liquid crystal layers, and makes use of the ability of an LC layer to selectively rotate a linear polarization direction of light passing through it. Each of the LC layers comprises a number of individually addressable pixels. The amount of rotation for polarized light passing through a pixel can be set independently for each pixel. In the simplest case, for black-and-white encoded images, a pixel can either be switched on for rotating passing polarized light over 90 degrees, or switched off in which case light can pass the pixel without modification. It should be noted that generally no linear polarizer is present between the LC layers.

For example, a key sequence is fed to the first LC layer, so that its pixels are arranged to represent a randomization pattern. If the first LC layer is fed with a wrong key sequence, the pixels of the first LC layer will be arranged in a randomization pattern that will not match with the encoded image in the second LC layer, and the device shows a random image to a viewer.

For the original image to become visible, in this example the encoded image data fed to the second LC layer has to include, in addition to the data of the encoded image, a randomization pattern matching with the randomization pattern represented by the key sequence fed to the first LC layer. The original image will then be displayed on the device because the matching randomization patterns in the LC layers effectively cancel out. The image can for example be made visible by placing the stacked LC layers between crossed polarizers.

However, the image quality of the reconstructed image may be rather poor, especially at oblique viewing angles.

It is an object of the invention to provide a display device suitable for visually reconstructing an image from an encoded image, wherein the reconstructed image has a relatively high image quality.

This object is achieved by means of a display device according to the invention, as specified in independent claim 1. Further advantageous embodiments are stated in the dependent claims.

A display device according to the invention includes means for improving an optical match between the two LC layers.

It has been found that a relatively low visual quality of the reconstructed image may result from dark pixels in the reconstructed image, which result from corresponding pixels of the first and second LC layers that are both switched off.

For example, when the LC layers are of the normally white (NW) type, such as twisted nematic LC layers with 90 degree twist angle, light passing through subsequent activated pixels (pixels that are switched on) of the LC layers remains essentially in the same polarization state. In this case the LC molecules in the activated pixels are mostly aligned along the direction of light passing through the pixel. Therefore passing linearly polarized light is not modified by either display, and the light exits from LC layer stack having substantially the same linear polarization direction as it had upon entry. When such a stack is placed between crossed polarizers, a black pixel of the reconstructed image resulting from activated pixels in both layers will have a relatively dark color.

When corresponding pixels of both layers are not activated (unswitched state), light passing through these pixels is in this example rotated over 180 degrees and, in an ideal situation, would exit from the layer stack also having substantially the same linear polarization direction as it had upon entry. However it was found that the resulting black pixel of the encoded image in practice shows relatively brightly, and moreover discoloration may occur. These effects decrease the visual quality of the reconstructed image visible on the device.

It is assumed that rotation of passing light in an unswitched LC layer pixel causes a small distortion in the passing light, so that the light effectively becomes slightly elliptically polarized. In a conventional LCD display device this is not a problem, as here an unswitched LCD pixel generally represents a white pixel in the displayed image, and the slight elliptical polarization of the light simply causes a small portion of the light to be absorbed in the front polarizer leading to a small and hardly noticeable loss of display brightness.

In the device according to the invention however, light may pass through subsequent unswitched pixels in the two LC layers, for creating a black pixel in the reconstructed image. In this situation, linearly polarized light passing the stack does not only have its polarization direction rotated over 180 degrees, but during its passage becomes elliptically polarized to a relatively large extent. Therefore, when the stack is placed between crossed polarizers, an undesirably large fraction of the light passes the front polarizer. Instead of a black pixel, a grey pixel appears in the visible encoded image, leading to loss of image quality. The effect is particularly noticeable when the reconstructed image is observed at an oblique viewing angle, i.e. when a viewer observes the LC layer stack off-axis.

In addition, the amount of elliptical polarization in the light passing the stack appears dependent on the wavelength, therefore the fraction of light passing the front polarizer would not be equal for any wavelength in the visible spectrum. In case broad spectrum light, e.g. white light, is used in the display device, this effect may cause a discoloration of pixels in the visible encoded image.

For reducing such effects, the device according to the invention comprises means for improving an optical match between the first and second layer. The inventors have experimented with a number of solutions to obtain an improved optical match between the displays, and have found two embodiments that give particularly good results.

In a first embodiment, an optical retarder is provided between the first and the second LC layers for improving the optical match. That is, an additional optically birefringent element is arranged between the two layers of the stack.

Preferably, the stack is arranged between crossed polarizers, that is on one side of the stack a first linear polarizer with a first polarization direction is provided, and on the other side of the stack and a second linear polarizer with a second polarization direction essentially perpendicular to the first polarization direction is provided. This embodiment is a transmissive display device, which relies on a dedicated backlight source behind the panel. A preferred optical retarder in this embodiment is a half-wave retarder (half lambda plate), and more preferably a half-wave retarder having its retardation axis aligned with either the first or second polarization direction.

In a second embodiment, the LC layers comprise twisted nematic (TN) liquid crystalline (LC) material, and the first layer is matched with the second layer by arranging the TN LC material in the layers to have opposite twist directions. It was shown by the inventors that in this case the elliptical polarizations gained in either layer substantially cancel out.

In a further embodiment, the display device is a reflective display device. Here, the layers are preferably arranged between a linear polarizer and a reflective means, such as an internal diffusive reflector (IDR). In accordance with the above, an optical match between the LC layers in the reflective display device is either improved by an optical retarder between the layers, in this case preferably a quarter-wave retarder having its retardation axis parallel to the third polarization direction, and/or by an opposite twist direction between twisted nematic LC material in the LC layers.

In general, any display system incorporating two or more liquid crystal layers cooperating to generate an image can benefit from means for improving an optical match between the layers, as set out in the above. In all such display systems, such means will improve the output image quality of the stacked LC layers. Preferably, the means include a retarder layer between adjacent liquid crystal layers. Alternatively, in case the liquid crystal layers are twisted nematic LC layers, the twisted nematic material in adjacent layers may be given opposite twist directions.

The invention will now be described and elucidated further with reference to the accompanying drawings. Herein:

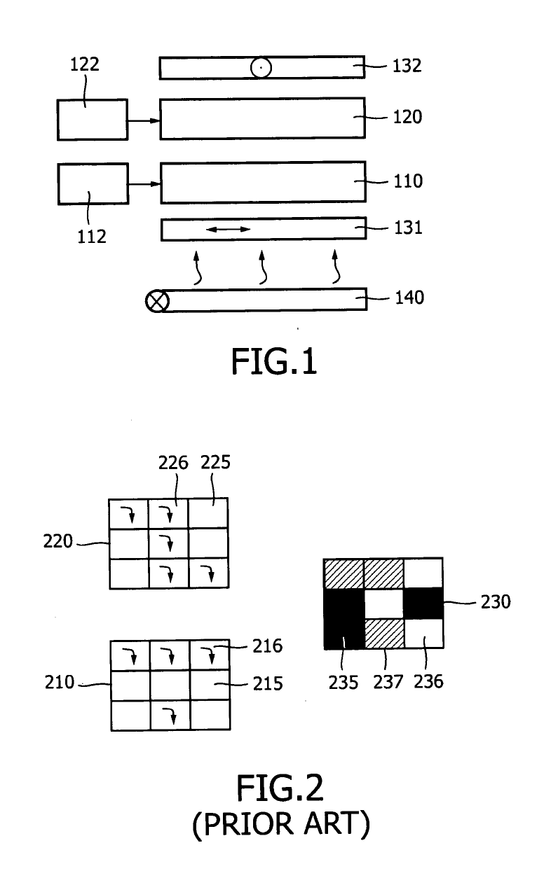

FIG. 1 shows a general implementation of a transmissive display device according to the invention;

FIG. 2 illustrates the reconstruction of an image from an encoded image and a matching randomization pattern, in accordance with the prior art;

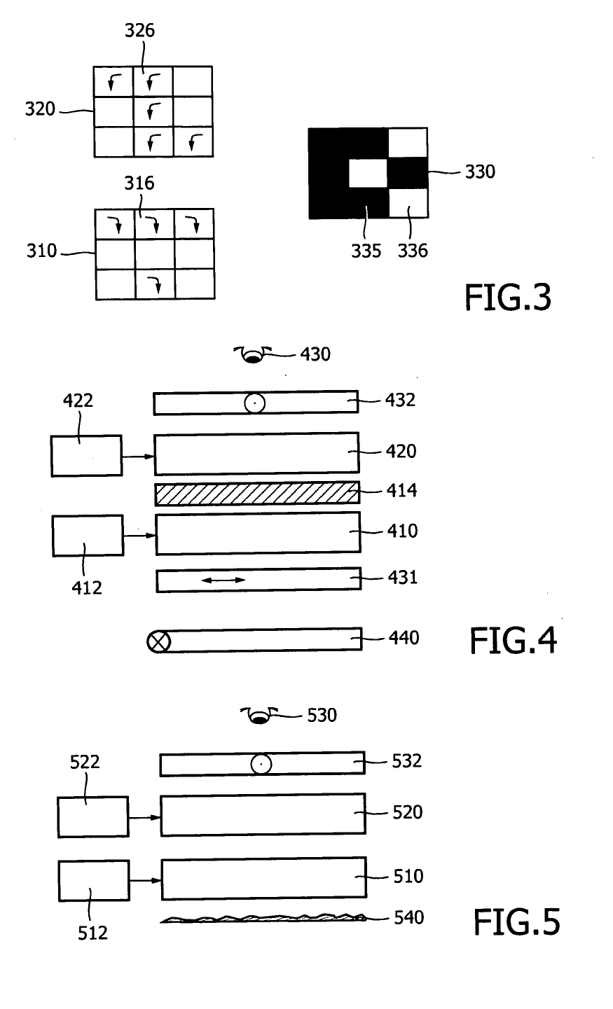

FIG. 3 illustrates the reconstruction of an image from an encoded image and a matching randomization pattern, in accordance with an embodiment of the present invention;

FIG. 4 shows a further embodiment of a transmissive display device according to the invention, and

FIG. 5 shows an embodiment of a reflective display device according to the invention.

In FIG. 1, a general implementation is shown of a transmissive display device for visually reconstructing an image from an encoded image. The device comprises a first liquid crystal layer 110 and a second liquid crystal layer 120. The layers 110, 120 are arranged between crossed linear polarizers 131, 132, i.e. on one side of the LCD stack a first linear polarizer 131 is provided having a first polarization direction and on the other side of the LC stack a second linear polarizer 132 is provided having a second polarization direction perpendicular to the first polarization direction.

The LC layers are preferably configured as normally white twisted nematic (TN) LC layers having a 90 degree twist angle. For such panels, when a pixel is switched off the polarization direction of passing linearly polarized light is rotated over 90 degrees, and when a pixel is fully switched on (maximum pixel voltage applied) passing linearly polarized light substantially goes through the pixel without modification of its polarization state.

Each LC layer is connected to its own controller 112, 122, so that the pixels in either LC layer can be switched on and off independently. The first and second controller 112, 122 are arranged to receive data in accordance with which the pixels of the associated LC layers 110, 120 can be addressed. Data sent to one of the controllers, for example the first controller 112, represents the encoded image, and data sent to the other LCD controller, for example the second controller 122, constitutes a key sequence for arranging the pixels of the associated layer, in this example the second layer 120, in accordance with a randomization pattern.

If the key sequence matches with the encoded image data, a viewer 130 sees the reconstructed original image on the display device, otherwise the viewer 130 observes a random pattern.

In the embodiment shown, the device is a transmissive display device, and a backlight 140 is provided behind the stack, as seen from the viewer 130. Light emitted by the backlight 140 is linearly polarized by the first linear polarizer 131. The linearly polarized light then passes through the stacked LC layers 110, 120. Each pixel of either layer may selectively modify the passing light by rotating its linear polarization direction. As a consequence, the second linear polarizer 132 either passes or (partially) absorbs light from each pixel, and the viewer 130 observes an image. If the randomization pattern presented by the first LC layer 110 matches with the encoded image presented by the second LC layer 120, the image seen by the viewer 130 on the display device will be the reconstructed original image.

In FIG. 2, the reconstruction of a black-and-white (1-bit) type image from an encoded image and a matching key sequence is illustrated. In this simplified example, a 3×3 block of pixels is shown for both LC layer 210, 220. In practical applications, the LC layers will have a substantially larger number of pixels, such as 320×240, 640×480 or more.

The pixels of first LC layer 210 are arranged according to a randomization pattern by feeding the key sequence to the controller associated with this first layer. An activated pixel 215 is blank, while an unswitched pixel 216 shows a twisting arrow. Similarly, the pixels of second LC layer 220 are arranged in accordance with encoded image data fed to the controller associated with the second layer. Again, an activated pixel 225 is blank, while an unswitched pixel 226 shows a twisting arrow.

When the layers are stacked in a configuration as shown in FIG. 1, the viewer will see an image like reconstructed image 230 on the display device. The image 230 is reconstructed from the encoded image 220 and randomization pattern 210 matching the encoded image 220. However the reconstructed image suffers from relatively poor visual quality, as it has not only has black pixels 235 and white pixels 236, but also a number of grey pixels 237 where black pixels would be expected. These grey pixels appear at locations where both the corresponding pixels of LCD panels 210 and 220 are activated and rotate passing light over 90 degrees.

The inventors have realized that, in addition to being rotated, light passing the LC layers becomes slightly elliptically polarized which causes undesirable light leakage through the front polarizer 132. Because of this light leakage, the corresponding pixel seen by the viewer 130 appears as grey instead of black. In greyscale images, a corresponding pixel would be seen as a lighter shade of grey as was present in the original image. Moreover, a discoloration may occur as explained earlier, especially for a device showing color images as in this case light leakage effect may only occur for a single primary color subpixel.

In an embodiment of a display device according to the invention, the light leakage is substantially reduced by improving an optical match between the LC layers. FIG. 3 illustrates the reconstruction of a black-and-white (1-bit) type image from an encoded image and a matching key sequence, in a display device according to the invention.

A difference is that pixels 316 of the LC layer 310, which are switched off, have opposite twist direction as pixels 326 of the LC layer 320, which are switched off. This is shown in the Figure by arrows twisting in opposite directions. As a result, if an unswitched pixel 316 in the first LC layer 310 rotates passing light over +90 degrees, an unswitched pixel 326 in the second LC layer 320 rotates passing light over −90 degrees. It has been found, surprisingly, that in this case light passing through subsequent unswitched pixels 316, 326 exits the layer stack without noticeable elliptical polarization. The optical match between the two LC layers is improved and, therefore, undesirable light leakage through the front polarizer 132 is substantially reduced. The reconstructed image 330 shows only black pixels 335 and white pixels 336, so that the image quality is improved.

An optical match between the LC layers is also improved in the embodiment depicted in FIG. 4. Here, a half wave retarder plate 414 is provided between the first LC layer 410 and the second LC layer 420. The retardation axis of the half wave retarder 414 is preferably either aligned with the polarization direction of the rear polarizer 431 or with the polarization direction of the front polarizer 432. Also in this embodiment, light passing through subsequent unswitched pixels is found to exit the LC layer stack without noticeable elliptical polarization, so that undesirable light leakage through the front polarizer 432 is substantially reduced and an improved image quality of the reconstructed image is obtained.

While the wave retarder plate by itself already significantly improves the optical match between the LCD panels, preferably it is combined with the measure of oppositely arranged twist direction of the LC material in the panels, as described with reference to FIG. 3.

In a further embodiment shown in FIG. 5, a device according to the invention is embodied as a reflective display device. A mirror 540 is provided behind the LC layers 510, 520, as seen from the viewer 530. Light, for example light emitted by a front light system, or ambient light, is linearly polarized by the linear polarizer 532. The linearly polarized light then passes through the stacked LC layers 510, 520, is reflected by the mirror 540 and again passes through the stack. Each pixel in either LC layer 510, 520 may selectively modify the passing light by rotating its linear polarization direction.

The LC layers 510, 520 preferably have a twist angle of 45 degrees. As the light passes each panel twice, in this case the operation of the reflective device can be similar to the operation of the previous embodiments.

Preferably, for improving the optical match between the LC layers 510, 520, the LC material in the layers 510 and 520 is arranged with opposite twist direction, so that for example the first layer 510 rotates light over +45 degrees for an unswitched pixel and the second layer 520 rotates light over −45 degrees for an unswitched pixel.

Alternatively, a quarter wave retarder (not shown) is arranged between layers 510 and 520 for improving an optical match. The quarter wave retarder preferably has its retardation axis aligned with the polarization direction of linear polarizer 532.

It should be noted that either of the LC layers may be embodied in a detachable unit, so that a user may carry a personal decryption device in the form of e.g. a smartcard containing one LC layer of the display device. For using the display device to visually reconstruct an encoded image, the user may bring the unit containing one of the LC layers in a stacked configuration with a device containing the other one of the LC layers.

Using a detachable unit such as a personal decryption device, the user can for example visually reconstruct an encoded image rendered on a device having a secure screen incorporating the other LCD panel, by overlaying his personal decryption device with the secure screen. The secure screen may for example be connected to a computer terminal, mobile phone, or an ATM machine at a bank.

Although the invention has predominantly been explained with respect to the example of a black-and-white image, a device according to the invention can easily be adapted to reconstruct greyscale or color images. An embodiment of a device for visually reconstructing an image from an encoded image including two LCDs, which device is specifically adapted for reconstructing greyscale or color images, is for example disclosed in the applicant's earlier international patent publication WO 2004/026394 A1. Means for improving optical match of the two LC layers, in accordance with the present invention, can be applied in this device without further modification, and the resulting device will fall under the scope of the claims. The means as set out in the present application are equally effective in case greyscale or color images are to be reconstructed. In all cases, a noticeable improvement in image quality of the reconstructed image can be observed.

In summary, the invention mainly relates to a display device for visually reconstructing an image from an encoded image. Such a device is particularly useful in the field of visual cryptography. The display device has two stacked liquid crystalline layers with individually addressable pixels. One layer renders encoded image data together with a randomization pattern, and the other layer only renders a randomization pattern. If the patterns match, the display device shows a visually reconstructed image to a viewer. Means are provided for improving an optical match between the LC layers, such as a birefringent layer between the two LC layers. Alternatively, two twisted nematic LC layers can be used having opposite twist directions. Such means were found to improve an image quality of the visually reconstructed image, and can in fact be advantageously applied in any display system including a plurality of LC layers cooperating for forming an image.

1. A display device for visually reconstructing an image (330) from an encoded image (320), including:
a first liquid crystal layer (420) for receiving the encoded image,
a second liquid crystal layer (410) for receiving a key sequence and cooperating with the first liquid crystal layer (420) to reconstruct the image from said encoded image and said key sequence, and
means (414) for improving an optical match between said first liquid crystal layer and said second liquid crystal layer.

2. The display device of claim 1, wherein said means include an optical retarder (414) arranged between the first and second liquid crystal displays.

3. The display device of claim 2, wherein the first and second liquid crystal displays are arranged between a first linear polarizer (431) with a first polarization direction and a second linear polarizer (432) with a second polarization direction essentially perpendicular to the first polarization direction, said optical retarder (414) being a half-wave retarder having its retardation axis parallel to either the first or the second polarization direction.

4. The display device of claim 1, wherein the first and second liquid crystal layers are arranged between a reflective means (540) and a linear polarizer (532) with a third polarization direction.

5. The display device of claim 2, wherein the optical retarder is a quarter-wave retarder having its retardation axis parallel to the third polarization direction.

6. The display device of claim 1, wherein said means include twisted nematic liquid crystal material in the first and the second liquid crystal displays, a twist sense of the liquid crystal material in the first display being opposite to a twist sense of the liquid crystal material in the second display.

7. A display system, including:
a first liquid crystal layer,
a second liquid crystal layer for cooperating with the first liquid crystal layer to display an image on the display system, and
means for improving an optical match between the first liquid crystal layer and the second liquid crystal layer.
